(19) United States
(12) Patent Application Publication
(10) Pub. No.: US 2008/0131168 A1
(43) Pub. Date: Jun. 5, 2008

(54) Image forming apparatus

(75) Inventors: Yasuhisa Ehara, Kanagawa (JP); Kazuhiko Kobayashi, Tokyo (JP); Joh Ebara, Kanagawa (JP); Toshiyuki Uchida, Kanagawa (JP); Noriaki Funamoto, Tokyo (JP); Keisuke Sugiyama, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD

(21) Appl. No.: 11/987,608

(22) Filed: Dec. 3, 2007

(30) Foreign Application Priority Data
Dec. 4, 2006 (JP) 2006-326516

(51) Int. Cl. G03G 15/00; G03G 15/01

(52) U.S. Cl. 399/167; 399/301

(57) ABSTRACT

An image forming apparatus includes at least first, second and third image carriers, a first drive source, a second drive source, at least one visible image forming mechanism for forming a visible image on the image carriers, a transfer unit for overlappingly transferring the visible images, an image detector, and a controller. The first drive source transmits a driving force to at least the first image carrier. The second drive source transmits a driving force to at least two image carriers other than the first image carrier. The controller calculates an amount of misalignment of the overlapped visible images that remain at the start timing of image formation based on the start timing of image formation after the timing correction, and separately determines driving speeds of the first and the second drive sources based on the amount of misalignment of the overlapped visible images.

### CROSS-REFERENCE TO RELATED APPLICATIONS

The present patent application is based on and claims priority under 35 U.S.C. §119 upon Japanese Patent Application No. 2006-326516 filed on Dec. 4, 2006 in the Japan Patent Office, the entire contents of which are incorporated herein by reference.

### BACKGROUND OF THE INVENTION

### Field of the Invention

Exemplary aspects of the present invention generally relate to an image forming apparatus such as a copier, a facsimile, and a printer, and more particularly, to an image forming apparatus which transfers visible images formed on a plurality of image carriers to a recording medium such as an intermediate transfer belt, a recording sheet and the like to overlap one another to form an overlapped image.

### DISCUSSION OF THE BACKGROUND

There is a type of an image forming apparatus that transfers visible images formed on a plurality of image carriers to a recording medium such as an intermediate transfer belt, a recording sheet and the like to form a multi-color image by overlapping the plurality of the visible images on one another. Such an image forming apparatus is disclosed, for example, in JP-2006-163056-A.

The image forming apparatus of this type includes four photoreceptors as image carriers for different colors, yellow (Y), magenta (M), cyan (C) and black (K). The letters Y, M, C, and K hereinafter refer to yellow, magenta, cyan and black, respectively.

Toner images of yellow, magenta, cyan and black formed on respective photoreceptors are overlappingly transferred onto an intermediate transfer belt serving as a transfer medium to form a multi-color image.

In the image forming apparatus, when the photoreceptors are each driven by a designated motor, a plurality of drive motors is needed, increasing the cost.

In the image forming apparatus disclosed in JP-2006-163056-A, the most frequently used photoreceptor, that is, the photoreceptor for black (K) is driven by the drive motor or a first drive motor while other photoreceptors for Y, M and C are driven by a second drive motor.

Such a configuration allows reduction of the number of drive motors, thereby reducing the cost compared with an image forming apparatus in which each of the photoreceptors is driven by a different drive motor.

Furthermore, when an image in black and white, which is the most frequently used image, is output, merely the first motor can be driven. Therefore, power consumption can be reduced, reducing operating costs.

However, misalignment of overlapped color toner images in a sub-scanning direction or a surface moving direction of the photoreceptors may be easily induced in such an image forming apparatus having a plurality of the photoreceptors.

Thus, when a temperature of an optical system that optically scans each photoreceptor fluctuates causing a fluctuation of a position of a light path, and/or an external force causes a relative position of each photoreceptor to vary, a start timing of optical writing of a latent image relative to the photoreceptors may fluctuate over time. Consequently, misalignment of color toner images occurs when overlapping one another, and has several undesirable results.

For example, when misalignment of color toner images occurs in a fine line image formed by overlapping a plurality of toner images of different colors, the fine lines appear blurry.

In addition, when misalignment of toner images of different colors occurs in a color image with a character image formed in a background image of a color other than white, a white void occurs around an outline of the character image.

Furthermore, when misalignment of color toner images occurs in the color image having a plurality of areas to be colored (a coloring area), a connecting area between the coloring areas of different colors may look like a streak of a different color, and/or may appear as a white void.

Furthermore, in the coloring areas, unevenness of image concentration may periodically occur in the form of a strip.

Such phenomena cause significant problems when attempting to accommodate demand for high-quality imaging in recent years.

In an attempt to solve these problems, an image forming apparatus disclosed in JP-2642351-B, for example, performs a timing correction to correct the start timing of optical writing of the latent image relative to each of the photoreceptors. Accordingly, misalignment of toner images of different colors in the sub-scan direction is suppressed.

In such timing correction, a predetermined reference toner image is formed on each photoreceptor at a predetermined timing. Subsequently, the reference toner image is transferred onto a front surface of a transfer medium, for example, a transfer belt, so as to obtain a reference image for misalignment detection (misalignment detection image).

Subsequently, based on the timing of detecting each reference toner image in the misalignment detection image by a photosensor, a drift amount relative to each reference toner image is calculated.

However, there is a drawback to such an approach. That is, even if the start timing of the optical writing is corrected, a slight drift equivalent to a length of 1 dot or less remains in the sub-scan direction. The reason is as follows.

In the image forming apparatus with a plurality of photoreceptors, in general, a single polygon mirror deflects scan light corresponding to each of the photoreceptors, in an effort to reduce the size of the optical writing unit. In such a structure, the start timing of the optical writing relative to each photoreceptor is adjusted only by a unit of time for writing 1 line or 1 scan.

For example, when there is misalignment of color toner images by ½ dot or more in the sub-scan direction between two photoreceptors, the start timing of the optical writing relative to one of the photoreceptors can be shifted back or forth by an amount equal to an integral multiple of the writing time for 1 line.

More particularly, when misalignment of ¾ dot occurs, for example, the start timing of the optical writing is shifted back or forth by the same amount of writing time for 1 line. When misalignment of 7/4 dot occurs, the start timing is shifted back or forth by twice the writing time for 1 line from the previous timing.

Accordingly, it is possible to reduce the amount of misalignment of the toner images in the sub-scan direction between two photoreceptors to the amount expressed by following equations:

1 dot−¾ dot=¼ dot and

2 dots−7/4 dot=¼ dot.

In other words, the amount of misalignment can be reduced to ½ dot or less.

However, when the amount of misalignment in the sub-scan direction is ½ dot, the amount of misalignment remains ½ dot even if the start timing of the optical writing is shifted by the writing time for 1 line.

Where the amount of misalignment in the sub-scan direction is less than ½ dot, when the start timing of the optical writing is shifted by the unit of writing time for 1 line, on the contrary the amount of misalignment may increase, so that the correction of the start timing of the optical writing cannot be performed.

As a result, drift of less than ½ dot remains between two photoreceptors.

Where a first photoreceptor, for example, a photoreceptor for black (K), of the four photoreceptors is a reference photoreceptor, when the toner images formed on the other photoreceptors drift upstream of the toner image formed on the first photoreceptor in the surface moving direction of the photoreceptor, the maximum drift amount is less than ½ dot.

Similarly, when the toner images formed on the photoreceptors drift further downstream, the maximum misalignment amount is less than ½ dot.

However, while a toner image formed on a second photoreceptor drifts upstream in the surface moving direction of the photoreceptor relative to the toner image formed on the first photoreceptor, a toner image formed on the third photoreceptor may drift downstream in the surface moving direction of the photoreceptor. In other words, the direction of the drift may not be consistent.

In such a case, the maximum misalignment amount may be close to 1 dot. Consequently, a slight misalignment of the color toner images that is the equivalent of 1 dot or less may not be prevented.

However, in order to accommodate increasing demand for a high quality image in recent years, misalignment of each toner image needs to be no more than 1 dot in the sub-scan direction.

### SUMMARY

In view of the foregoing, exemplary embodiments of the present invention provide an image forming apparatus that transfers visible images formed on a plurality of image carriers to a recording medium such as an intermediate transfer belt, a recording sheet and the like.

In one exemplary embodiment, the image forming apparatus includes at least three image carriers, a first drive source, a second drive source, at least one visible image forming mechanism, a transfer unit, an image detector, and a controller.

The three image carriers includes a first, a second and a third image carriers each having a movable surface and bearing a visible image on the surface. The first drive source transmits a driving force to at least the first image carrier. The second drive source transmits a driving force to at least two image carriers other than the first image carrier. The visible image forming mechanism forms a visible image on the image carriers based on image information. The transfer unit overlappingly transfers the visible images borne on the image carriers to a surface of a transfer member. The image detector detects the visible images on the transfer member and detects a misalignment detection image formed of a predetermined visible image for detecting misalignment of the visible images when overlapped each other. The controller forms the misalignment detection image on the image carriers, transfers the misalignment detection image onto the surface of the transfer member, and performs a timing correction to correct a start timing of image formation on the image carriers based on a detection timing of the image detector that detects the visible images in the misalignment detection image so as to reduce misalignment of the overlapped visible images.

The controller calculates an amount of misalignment of the overlapped visible images that remain at the start timing of image formation based on the start timing of image formation after the timing correction, and separately determines driving speeds of the first drive source and the second drive source based on the amount of misalignment of the overlapped visible images.

The controller further performs an image forming processing to form an image based on the image information while separately driving the first and the second drive sources driven at the respective driving speeds separately determined.

Another exemplary embodiment provides a controller that calculates the amount of misalignment of the overlapped visible images among the visible images formed on the first image carrier at the start timing of image formation after the timing correction and the visible images formed on at least two other image carriers at the separate start timing of image formation after the timing correction, and individually determines the driving speeds of the first and the second drive sources based on a middle value between a maximum value and a minimum value of the calculation result.

Yet another exemplary embodiment provides a second drive source that drives at least three image carriers including a second image carrier on which a visible image of yellow is formed, and third and fourth image carriers on which visible images of different colors other than yellow are each formed.

The controller calculates the amount of misalignment of the overlapped visible images among the visible image formed on the first image carrier at the start timing of image formation after the timing correction and the visible images of non-yellow formed on the third image carrier or the fourth image carrier at the separate start timing of image formation after the timing correction, and individually determines the driving speeds of the first drive source and the second drive source based on a middle value between a maximum value and a minimum value of the calculation result.

Yet another and further exemplary embodiment provides a controller that calculates the amount of misalignment of the overlapped visible images among the visible image formed on the first image carrier and the visible images formed on other two or more image carriers driven by the second drive source, and separately corrects the start timing of image formation relative to each image carriers based on the calculation result.

Still yet another and further exemplary embodiment provides a controller that calculates the amount of misalignment of the overlapping toner images among the visible images formed on two image carriers driven by the second drive source, and separately corrects the start timing of image formation relative to each image carrier based on the calculation result.

Still yet another and further exemplary embodiment provides a controller that calculates the amount of misalignment of the overlapped visible images remaining at the start timing of image formation after the timing correction by adding a predetermined value to the amount of misalignment based on the detection timing of the visible images in the misalignment detection image.

Still yet another and further exemplary embodiment provides a controller that switches image forming speeds between a first printing speed and a second printing speed different from the first printing speed in accordance with a predetermined instruction when the image forming processing is performed.

The controller separately corrects the start timing of image formation at the first printing speed and the start timing of image formation at the second printing speed for all the image carriers, and determines the driving speeds of the first drive source and the second drive source for the first printing speed and the second printing speed.

Additional features and advantages of the present invention will be more fully apparent from the following detailed description of exemplary embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of exemplary embodiments when considered in connection with the accompanying drawings, wherein:

FIG. 1 is a schematic diagram illustrating an image forming apparatus, for example a printer, according to an exemplary embodiment of the present invention;

FIG. 2 is an enlarged view illustrating a process unit for black of the printer of FIG. 1;

FIG. 3 is a block diagram illustrating a portion of an electrical circuit of the printer of FIG. 1 according to an exemplary embodiment;

FIG. 4 is a perspective view illustrating a portion of an intermediate transfer belt and an optical sensor unit of the printer according to an exemplary embodiment;

FIG. 5 is a schematic diagram illustrating a misalignment detection image formed by the printer according to an exemplary embodiment;

FIG. 6 is a flowchart showing an exemplary timing correction procedure performed by a controller of the printer according to an exemplary embodiment;

FIG. 7 is a perspective view illustrating an optical writing unit for cyan and a photoreceptor for cyan according to an exemplary embodiment;

FIG. 8 is an enlarged view illustrating photoreceptor gears for magenta, cyan, yellow and black, and peripheral structures, according to an exemplary embodiment;

FIG. 9 is a schematic diagram illustrating a first example of misalignment of color toner images;

FIG. 10 is a schematic diagram illustrating a case in which a start timing of optical writing after correction is employed in the first example of misalignment of color toner images;

FIG. 11 is a schematic diagram illustrating a second example of misalignment of color toner images;

FIG. 12 is a schematic diagram illustrating a case in which a start time of optical writing after correction is employed in the second example of misalignment of color toner images according to another exemplary embodiment; and

FIG. 13 is a schematic diagram illustrating misalignment of color toner images after a controller individually determines driving speeds in the printer according to an exemplary embodiment.

### DETAILED DESCRIPTION OF EXEMPLARY EMBODIMENTS

It will be understood that if an element or layer is referred to as being “on,” “against,” “connected to” or “coupled to” another element or layer, then it can be directly on, against connected or coupled to the other element or layer, or intervening elements or layers may be present.

In contrast, if an element is referred to as being “directly on”, “directly connected to” or “directly coupled to” another element or layer, then there are no intervening elements or layers present. Like numbers refer to like elements throughout.

As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures.

For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms.

These terms are used only to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing exemplary embodiments illustrated in the drawings, specific terminology is, employed for the sake of clarity. However, the disclosure of this patent specification is not intended to be limited to the specific terminology so selected and it is to be understood that each specific element includes all technical equivalents that operate in a similar manner.

Exemplary embodiments of the present invention are now explained below with reference to the accompanying drawings.

In the later-described comparative example, exemplary embodiment, and alternative example, for the sake of simplicity of drawings and descriptions, the same reference numerals will be given to constituent elements such as parts and materials having the same functions, and the descriptions thereof will be omitted unless otherwise stated.

Typically, but not necessarily, paper is the medium from which is made a sheet on which an image is to be formed. Other printable media is available in sheets and their use here is included.

For simplicity, this Detailed Description section refers to paper, sheets thereof, paper feeder, etc. It should be understood, however, that the sheets, etc., are not limited only to paper.

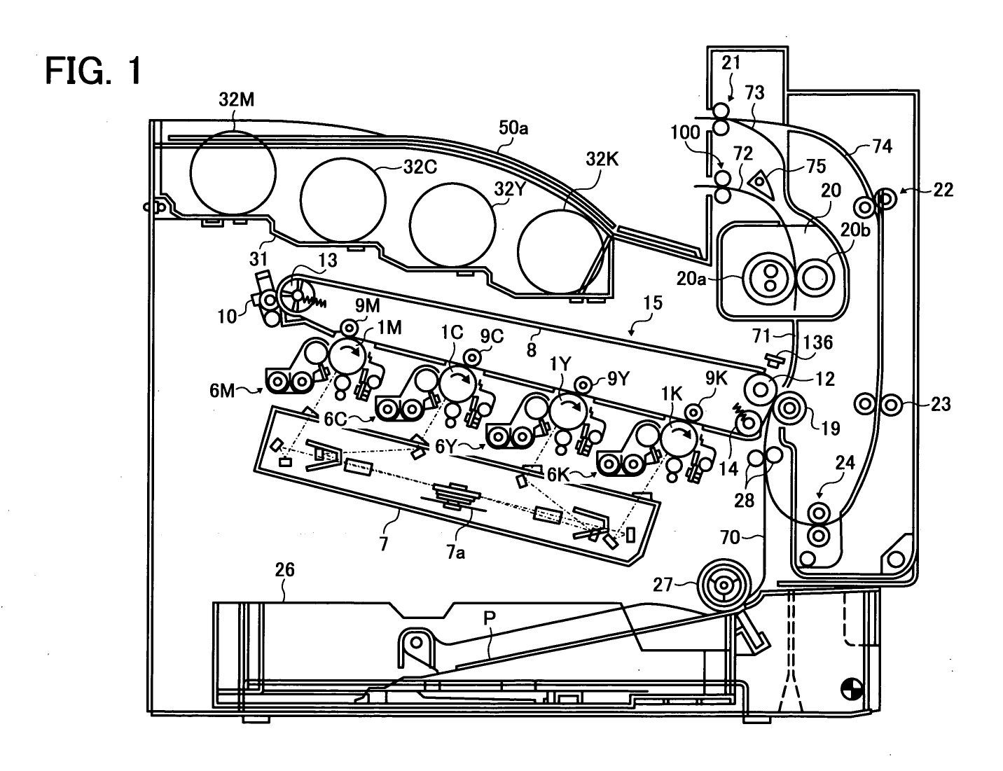

Referring now to the drawings, wherein like reference numerals designate identical or corresponding parts throughout the several views, particularly to FIG. 1, an image forming apparatus, for example, a printer according to an exemplary embodiment of the present invention is described.

A description will be given of an image forming apparatus, for example, an electrophotography printer (hereinafter referred to as a printer) according to a first exemplary embodiment.

Referring now to FIG. 1, there is provided a schematic diagram illustrating a printer according to one exemplary embodiment of the present invention.

As shown in FIG. 1, the printer includes at least four process units 6M, 6C, 6Y and 6K that form toner images of magenta (M), cyan (C), yellow (Y) and black (K), respectively. The process units 6M, 6C, 6Y and 6K use toners of different colors of magenta, cyan, yellow and black, as image forming agents. When reaching the end of their working life, the process units 6M, 6C, 6Y and 6K are replaced.

Other structures except the image forming agents of the process units 6M, 6C, 6Y and 6K are similar if not identical to each other. Thus, a description will be given of the process unit 6K for forming a black toner image as a representative example of the process unit.

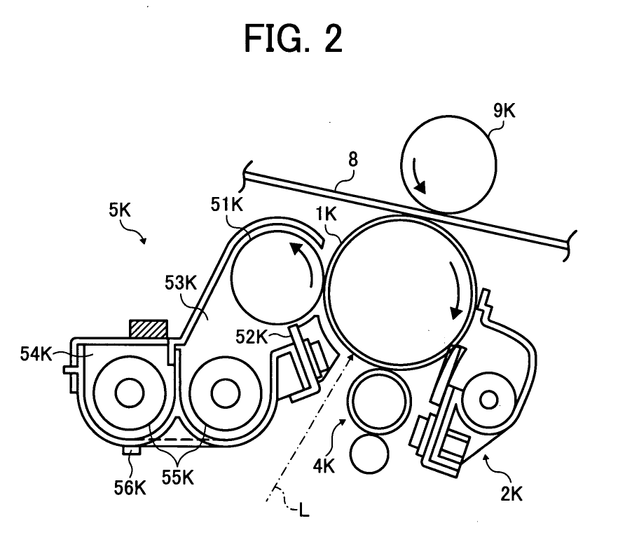

As shown in FIG. 2, the process unit 6K includes a drum-type photoreceptor 1K serving as an image carrier, a drum cleaning unit 2K, a discharge unit, not shown, a charger 4K, a developing unit 5K and so forth.

The process unit 6K is detachably provided relative to the printer, and thus it is possible to replace consumables at once.

The charger 4 evenly charges a surface of the photoreceptor 1 in the dark while the photoreceptor 1 is rotated in a clockwise direction in the figure by a driving mechanism, not shown. The charged surface of the photoreceptor 1 is exposed and scanned with a laser beam L, and bears an electrostatic latent image in black.

The developing unit 5K develops the black electrostatic latent image so as to form a visible image, that is, a black toner image using a black developer (hereinafter referred to as developer K) that includes black toner (hereinafter referred to as toner K) and magnetic carriers.

The black toner image is intermediately transferred to a later-described intermediate transfer belt 8.

The drum cleaning unit 2K removes the toner K remaining on the surface of the photoreceptor 1K after an intermediate transfer process. The discharge unit discharges any residual charge on the photoreceptor 1K after cleaning. Through the discharging process, the surface of the photoreceptor 1K is initialized and prepared for a subsequent image forming operation.

Similar to the process unit 6K, in the process units of 6M, 6C and 6Y, the visible images of magenta, cyan and yellow, that is, the toner images of magenta, cyan and yellow, respectively, are formed on the respective photoreceptors 1M, 1C and 1Y. The toner images of magenta, cyan and yellow are overlapped on one another and intermediately transferred to the intermediate transfer belt 8.

The developing unit 5K includes a developing roller 51, two conveyance screws 55K, a doctor blade 52K, toner density sensor (hereinafter referred to as a T sensor) 56K and so forth.

The developing roller 51 is provided such that a portion thereof is exposed from an opening of a casing of the developing unit 5K. The conveyance screws 55K are disposed parallel to each other.

The developer K in the casing of the developing unit 5K is agitated and transported by the conveyance screws 55K while being frictionally charged. Subsequently, the surface of the developing roller 51K bears the developer K.

A thickness of the developer K is regulated by the doctor blade 52K and transported to a developing region facing the photoreceptor 1K for black. In the developing region, the toner K adheres to the electrostatic latent image of black on the photoreceptor 1K.

The toner K is consumed during development. The developer K from which the toner K is consumed during the development is recovered to the inside of the casing along with the rotation of the developing roller 51K.

A dividing wall is provided between the left and right conveyance screws 55K. The dividing plate separates a first supply unit 53K and a second supply unit 54K in the casing.

The first supply unit 53K at least includes the developing roller 51K and one of the conveyance screws 55K on the right or the right conveyance screw 55K. The second supply unit 54K at least includes another conveyance screw 55K on the left or the left conveyance screw 55K.

The right conveyance screw 55K in FIG. 2 is driven to rotate by a driving mechanism, not shown. The right conveyance screw 55K transports the developer K in the first supply unit 53K from the front to the rear in the figure so as to supply the developer K to the developing roller 51K.

The developer K transported to the vicinity of an end portion of the first supply unit 53K advances to the second supply unit 54K through an opening, not shown, provided in the dividing wall.

In the second supply unit 54K, the conveyance screw 55K on the left in the figure is driven to rotate by the driving mechanism, not shown, and transports the developer K transported from the first supply unit 53K to the direction opposite to the right conveyance screw 55K.

The developer K transported to the vicinity of an end portion of the second supply unit 54K by the left conveyance screw 55K is recovered to the inside of the first supply unit 53K through another opening, not shown, provided in the dividing wall.

The T sensor 56K including a permeability sensor is provided to a bottom wall of the second supply unit 54K and outputs a voltage according to a permeability of the developer K passing over the T sensor 56K.

The permeability of a two-component developer consisting of toner and the magnetic carriers is closely correlated with toner density. Thus, the T sensor 56K outputs a voltage the size or value of which varies according to the toner density of the toner K.

The value of the output voltage is transmitted to a controller, not shown. The controller includes a RAM. The RAM stores a Vtref for black (K), which is a target value for the output voltage from the T sensor 56K.

The RAM also stores a Vtref for magenta (M), a Vtref for cyan (C) and a Vtref for yellow (Y), which are the target values for T sensors for M, C and Y, respectively.

The Vtref for black is used for operational control of a toner transport unit for the toner K, not shown. The controller controls the operation of the toner transport unit for the toner K such that the output voltage from the T sensor 56K approximates the Vtref for black, and supplies the toner K to the second supply unit 54K.

Accordingly, the toner density of the toner K in the developer K in the developing unit 5K is maintained within a predetermined value.

Other developing units 5M, 5C and 5Y of the process units 6M, 6C and 6Y, respectively perform a similar toner supply control as that of the developing unit 5K using the toner transport units for magenta, cyan and yellow.

As shown in FIG. 1, an optical writing unit 7 serving as a latent image forming mechanism is provided beneath the process units 6M, 6C, 6Y and 6K. The optical writing unit 7 scans each of the photoreceptors 1M, 1C, 1Y and 1K of the respective process units 6M, 6C, 6Y and 6K with a laser beam L. The laser beam L is emitted according to image information transmitted from an external personal computer, not shown, or the like.

Accordingly, electrostatic latent images of magenta, cyan, yellow and black are formed on the photoreceptors 1M, 1C, 1Y and 1K, respectively. In the optical writing unit 7, the laser beam L emitted from a light source is deflected in the main scan direction by a polygon mirror which is rotatively driven by a motor so that the photoreceptors 1M, 1C, 1Y and 1K are irradiated through a plurality of optical lenses and mirrors.

A sheet storage mechanism, which includes a sheet feed cassette 26 and a sheet feed roller 27 installed in the sheet feed cassette 26, is provided below the optical writing unit 7.

The sheet feed cassette 26 stores a plurality of recording sheets P stacked on one another. The sheet feed roller 27 is in contact with the top sheet of the recording sheets P.

When the sheet feed roller 27 is rotated in a counter-clockwise direction by a driving mechanism, not shown, the top sheet of the recording sheet P is fed to a sheet feed path 70.

Near the end of the sheet feed path 70, a pair of registration rollers 28 is provided. The registration rollers 28 rotate so as to pinch or nip the recording sheet P. Immediately after nipping the recording sheet P, the registration rollers 28 temporarily stop. Subsequently, at an appropriate timing, the registration rollers 28 feed the recording sheet P to a later-described secondary transfer nip.

A transfer unit 15 serving as a transfer mechanism which spans the endless intermediate transfer belt 8 and moves the intermediate transfer belt 8 in an endless loop is provided above the process units 6M, 6C, 6Y and 6K. The transfer unit 15 at least includes the intermediate transfer belt 8, a secondary transfer bias roller 19, a cleaning unit 10, four primary transfer bias rollers 9M, 9C, 9Y and 9K, a secondary transfer backup roller 12, a cleaning backup roller 13, a tension roller 14, and so forth.

The intermediate transfer belt 8 is stretched between the above rollers and travels in an endless loop. The rotary operation of at least one of the rollers described above causes the intermediate transfer belt 8 to travel in an endless loop in the counter-clockwise direction.

The intermediate transfer belt 8 is pinched between the primary transfer bias rollers 9M, 9C, 9Y, and 9K, and the photoreceptors 1M, 1C, 1Y and 1K to form a primary transfer nip therebetween. A transfer bias of the opposite polarity to that of the toner, for example, a positive polarity, is applied to a rear surface (an inner loop) of the intermediate transfer belt 8.

The rollers except the primary transfer rollers 9M, 9C, 9Y and 9K are electrically connected to ground.

When the intermediate transfer belt 8 passes the primary transfer nips for magenta, cyan, yellow and black along with its endless movement, the toner images of magenta, cyan, yellow and black on the photoreceptor 1M, 1C, 1Y and 1K are sequentially transferred to the intermediate transfer belt 8 one on top of another, in a so-called primary transfer.

Accordingly, a composite toner image of four colors (hereinafter referred to as a four-color toner image) is formed on the intermediate transfer belt 8.

The secondary transfer backup roller 12 provided to the inner surface of the belt loop nips the intermediate transfer belt 8 with the secondary transfer roller 19, thereby forming a secondary transfer nip.

The four-color toner image formed on the intermediate transfer belt 8 is secondarily transferred to the recording sheet P at the secondary transfer nip. Accordingly, the full-color toner image is formed on the recording sheet P.

After passing the secondary transfer nip, the residual toner which has not been transferred to the recording sheet P adheres to the intermediate transfer belt 8. The residual toner is cleaned by the cleaning unit 10.

After the transfer process, the recording sheet P on which the four-color image is secondarily transferred at the secondary transfer nip is transported to a fixing unit 20 through a conveyance path 71.

The fixing unit 20 includes a fixing roller 20a and a pressure roller 20b. The fixing roller 20a includes a heat source such as a halogen lamp inside thereof. The pressure roller 20b rotates while coming into contact with the fixing roller 20a at a predetermined pressure so as to form a fixing nip therebetween.

The recording sheet P sent into the fixing unit 20 is nipped in the fixing nip such that the surface on which a unfixed toner image is bore closely abuts the fixing roller 20a. Through application of heat and pressure, the toner in the toner image is softened, and the full color image is fixed.

The recording sheet P on which the full-color image is fixed in the fixing unit 20 exits the fixing unit 20 and advances to a separation point between a sheet discharge path 72 and a conveyance path 73.

A first switching pawl 75 is swingably provided at the separation point. The course of the recording sheet P is switched by swinging the first switching pawl 75. When the tip of the first switching pawl 75 is moved to the direction toward the conveyance path 73, the course of the recording sheet P is directed toward the sheet discharge path 72.

When the tip of the first switching pawl 75 is moved away from the conveyance path 73, the course of the recording sheet P is directed toward the conveyance path 73.

When the sheet discharge path 72 is selected as the course of the recording sheet P by the first switching pawl 75, the recording sheet P is discharged from the printer from the sheet discharge path 72 by a pair of sheet discharge rollers 100.

Subsequently, the recording sheet P is stacked on a sheet output tray 50a provided on the top surface of the printer.

By contrast, when the sheet discharge path 73 is selected as the course of the recording sheet P by the first switching pawl 75, the recording sheet P advances to a nip between a pair of sheet reversing rollers 21 by way of the conveyance path 73.

The sheet reversing rollers 21 pinch the recording sheet P therebetween and transport the recording sheet P to the sheet output tray 50a. However, the sheet reversing rollers 21 are reversely rotated immediately before the rear end of the recording sheet P advances to the nip.

According to the reverse rotation, the recording sheet P is transported in an opposite direction, and the rear end of the recording sheet P advances to a reverse conveyance path 74.

The reverse conveyance path 74 extends vertically from the upper side to the lower side and is relatively curved.

Along the reverse conveyance path 74 are provided a pair of first reverse conveyance rollers 22, a pair of second reverse conveyance rollers 23 and a pair of third reverse conveyance rollers 24.

The recording sheets P are each transported sequentially between the rollers. Accordingly, the top and the bottom of the recording sheet P are reversed. After being reversed, the recording sheet P is guided to the sheet feed path 70 and transported to the secondary transfer nip again.

Subsequently, a non-image bearing surface of the recording sheet P advances to the secondary transfer nip while closely contacting the intermediate transfer belt 8 so that a second four-color toner image on the intermediate transfer belt is secondarily transferred to the non-image bearing surface.

After that, the recording sheet P is stacked on the sheet output tray 50a by way of the conveyance path 71, the fixing unit 20, the sheet discharge path 72 and the sheet discharge rollers 100. Through such reverse conveyance, a full-color image is formed on both sides of the recording sheet P.

Between the transfer unit 15 and the sheet output tray 50a is provided a bottle supporting unit 31. The bottle supporting unit 31 includes toner bottles 32M, 32C, 32Y and 32K for storing toners of magenta, cyan, yellow and black, respectively.

The toner bottles 32M, 32C, 32Y and 32K are arranged side by side at a slight angle to the horizontal, in order from magenta to cyan, yellow and black.

The toners of magenta, cyan, yellow and black in the toner bottles 32M, 32C, 32Y and 32K are supplied to the respective developing units of the process units 6M, 6C, 6Y and 6K by toner transport units, not shown, as needed. The toner bottles 32M, 32C, 32Y and 32K can be detached from the printer, separately from the process units 6M, 6C, 6Y and 6K.

The photoreceptors 1M, 1C, 1Y and 1K are each rotatively supported by a shaft bearing, not shown, of a rotary shaft provided in the center of rotation. A gear is fixedly provided to each of the rotary shafts of the photoreceptors 1M, 1C, 1Y and 1K. Each gear meshes with a gear of a driving side, not shown, and rotates together with the respective photoreceptor.

At the upper right of the transfer unit 15 is provided an optical sensor unit 136 facing an upper spanned surface of the intermediate transfer belt 8 with a predetermined gap therebetween.

The optical sensor unit 136 includes at least two reflective photosensors, not shown, arranged at predetermined intervals. A description of the optical sensor unit 136 will be provided later.

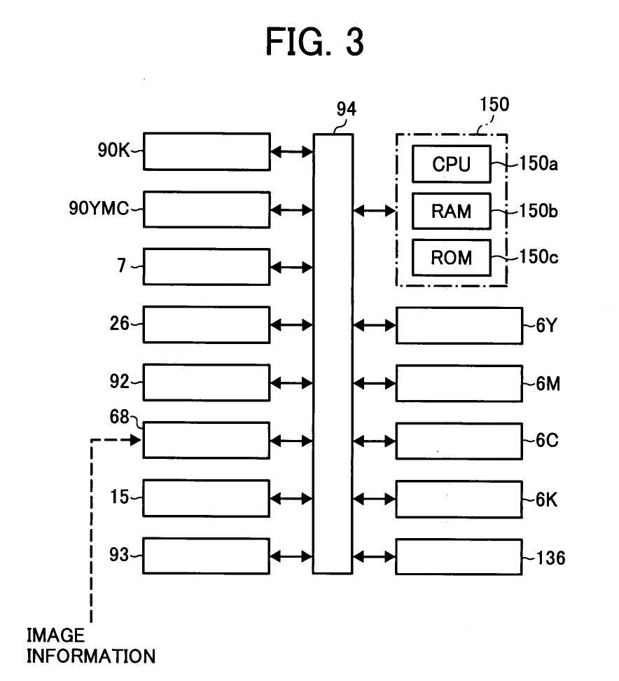

Referring now to FIG. 3 there is provided a block diagram illustrating a portion of an electric circuit of the printer according to the exemplary embodiment.

Components connected to a bus 94 are: The process units 6M, 6C, 6Y and 6K; the optical writing unit 7; the sheet feed cassette 26; a registration motor 92; a data input port 68; the transfer unit 15; an operation display unit 93; the optical sensor unit 136; a controller 150 and so forth.

The registration motor 92 is a drive source of the above-described pair of registration rollers 28. The data input port 68 is configured to receive image information from an external personal computer, not shown, or the like. The controller 150 serving as a control mechanism controls the operation of the printer and includes a CPU 150a, a RAM 150b serving as an information storage medium, a ROM 150c and so forth.

The operation display unit 93 includes a touch panel (touch screen) or a liquid crystal panel and a plurality of touch keys. According to the control operation of the controller 150, the operation display unit 93 displays various information and sends information input by an operator to the controller 150.

Generally, in the image forming apparatus, when the internal temperature of the apparatus changes, and/or an external force acts on the process units, a slight fluctuation in the position and the size of the process units may occur.

When, for example, recovering from paper jams, replacing parts upon maintenance, or moving the image forming apparatus, an external force is applied to the process units. When such an external force and/or the temperature fluctuation described above occurs, the light path of the laser beam emitted from the optical writing unit 7 fluctuates slightly, causing the writing position of the light in the sub-scan position relative to the photoreceptors 1M, 1C, 1Y and 1K to fluctuate slightly as well.

Consequently, misalignment of toner images of magenta, cyan, yellow and black occurs.

In light of the above, the printer according to the present exemplary embodiment performs timing correction immediately after the power is turned on and/or when a predetermined time elapses. Accordingly, misalignment of color toner images can be reduced, if not prevented entirely.

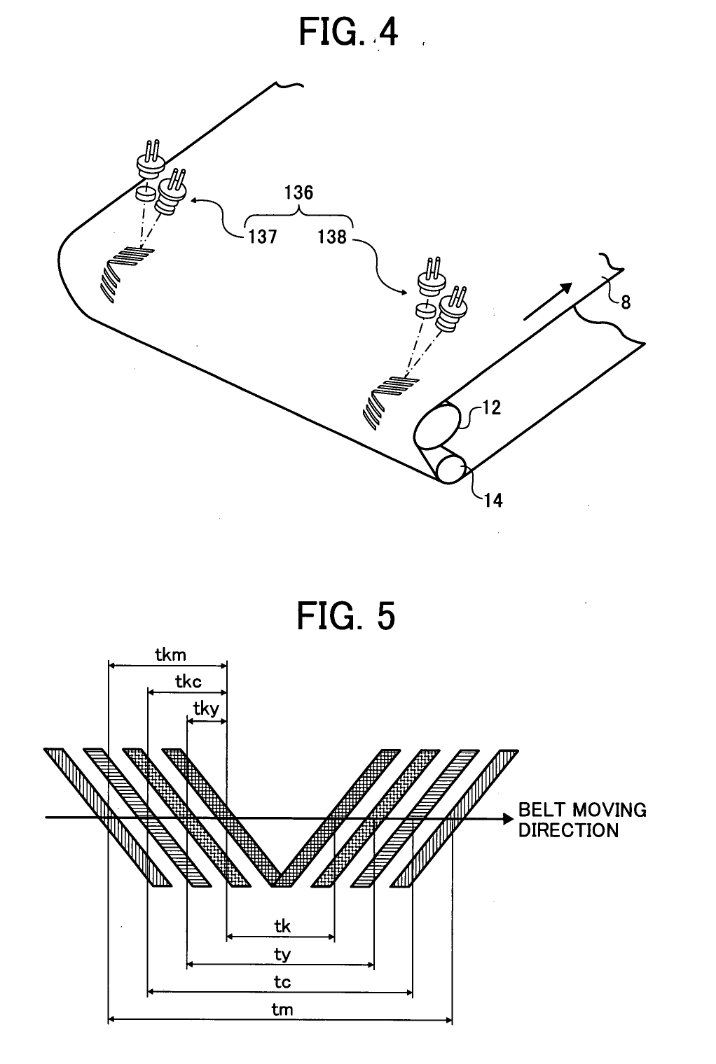

Referring now to FIG. 4 there is provided a perspective view illustrating a portion of the intermediate transfer belt 8 and the optical sensor unit 136.

The controller 150 of the printer is configured to perform the timing correction at certain times, for example, immediately after a power switch, not shown, is turned on or when a predetermined time elapses.

In the timing correction, a misalignment detection image for detecting misalignment is formed at both one end portion of the intermediate transfer belt 8 and the other end portion thereof in a width direction. The misalignment detection image for detecting misalignment consists of a plurality of the toner images.

At the upper side of the intermediate transfer belt 8 is provided the optical sensor unit 136 serving as an image detecting mechanism. The optical sensor unit 136 includes a first optical sensor 137 and a second optical sensor 138.

The first optical sensor 137 causes the light emitted from the light emission unit to pass through a light collecting lens and to be reflected on the surface of the intermediate transfer belt 8. The reflected light is received by a light receiving mechanism. Subsequently, a voltage the size of which varies according to the amount of light received is output.

When the toner images in the misalignment detection image for detecting misalignment formed at one end of the intermediate transfer belt 8 in the width direction pass a position immediately below the first, optical sensor 137, the amount of light received by the light receiving mechanism of the first optical sensor 137 changes dramatically.

Consequently, the first optical sensor 137 detects the toner image and changes an output voltage from the light receiving mechanism dramatically.

Similarly, the second optical sensor 138 detects each of the toner images in the misalignment detection image formed at the other end of the intermediate transfer belt 8 in the width direction.

In such a manner, the optical sensor unit 136, including the first optical sensor 137 and the second optical sensor 138, serves as the image detecting mechanism for detecting the toner images in the misalignment detection image.

As a light emitting mechanism, an LED or the like having a light intensity capable of producing a reflective light necessary to detect the toner images is used.

As a light receiving mechanism, a CCD or the like in which a plurality of light receiving elements are linearly arrayed is used.

As shown in FIG. 4, when the controller 150 of the printer starts the timing correction, the misalignment detection image for detecting misalignment is formed at both ends of the intermediate transfer belt 8 in the width direction.

Subsequently, the optical sensor unit 136 detects the toner images in the misalignment detection image. Based on the detection timing, a position of each toner image in the main scan direction or the scan direction of the laser beam, a position of each toner image in the sub-scan direction or the belt traveling direction, a magnification error in the main scan direction, and skew from the main scan direction are identified.

While being transported to the position opposite to the optical sensor unit 136 along with the belt, the misalignment detection image passes a position opposite the secondary transfer bias roller 19 of FIG. 1 on the way to the position opposite the optical sensor unit 136.

At this time, if the secondary transfer bias roller 19 is in contact with the intermediate transfer belt 8 forming the secondary transfer nip, the misalignment detection image on the intermediate transfer belt 8 comes into contact with the secondary transfer roller 19 so that the misalignment detection image is transferred to the roller surface.

According to this embodiment, when the timing correction is performed, the controller 150 drives a roller separation mechanism, not shown, so as to separate the secondary transfer bias roller 19 from the intermediate transfer belt 8.

Accordingly, it is possible to prevent the misalignment detection image for detecting misalignment from transferring to the secondary transfer bias roller 19.

The misalignment detection image for detecting misalignment includes a line pattern group, a so-called “chevron patch”, as shown in FIG. 5. The misalignment detection image includes the toner images of magenta, cyan, yellow and black arranged in an inclined manner at approximately 45 degrees from the main scan direction or the laser beam moving direction on the photoreceptor surface, and moreover disposed at predetermined intervals in the belt traveling direction corresponding to the sub-scan direction.

A difference between a detection time of the toner image K and detection times of the toner images M, C and Y in the misalignment detection image is read. In FIG. 5, a vertical direction corresponds to the main scan direction, and a horizontal direction shown by an arrow corresponds to the sub-scan direction.

In the misalignment detection image, the toner images M, C, Y and K are arranged from left to right in FIG. 5. Following the toner images M, C, Y and K are arranged the toner images M, C, Y and K from right to left, slanted 90 degrees from the position of the previous toner images M, C, Y and K.

In the printer of the present exemplary embodiment the reference color is black. Based on a difference between an actual measurement and a theoretical value of the detection time difference tmk, tck and tyk between a detection timing of the reference color, that is, the toner image K, and a detection timing of the toner images M, C and Y, the controller 150 obtains an amount of misalignment between the toner image K, and the toner images M, C and Y in the sub-scan direction. Moreover, the amount of misalignment is proportional to the amount of misalignment of each toner image on the intermediate transfer belt.

When the amount of misalignment in the sub-scan direction is obtained, the amount of misalignment of each toner image is indirectly obtained. Based on the amount of misalignment, the start timing of optical writing relative to each photoreceptor can be corrected for every other mirror surface of the polygon mirror of the optical writing unit 7. In other words, the start timing of optical writing is corrected for a single scan line pitch as one unit. Accordingly, misalignment of each toner image in the sub-scanning direction is reduced, if not prevented entirely.

Furthermore, based on the difference between the actual measurement and the theoretical value of the detection time difference (tk, ty, tc and tm) between two-toner images of the same color angled 90 degrees relative to each other, the amount of misalignment of each toner image in the main scan direction is obtained. Based on the amount of misalignment in the sub-scan direction between the belt edges, an angle or skew of the toner images from the main scan direction is obtained.

According to the above-described results, a lens position adjustment mechanism, not shown, for adjusting an angle of a toroidal lens, not shown, is operated to reduce the drift of the angle of the toner images in the main scan direction.

The corrections described above can be performed by changing the parameters for yellow, cyan and magenta while using black as a reference.

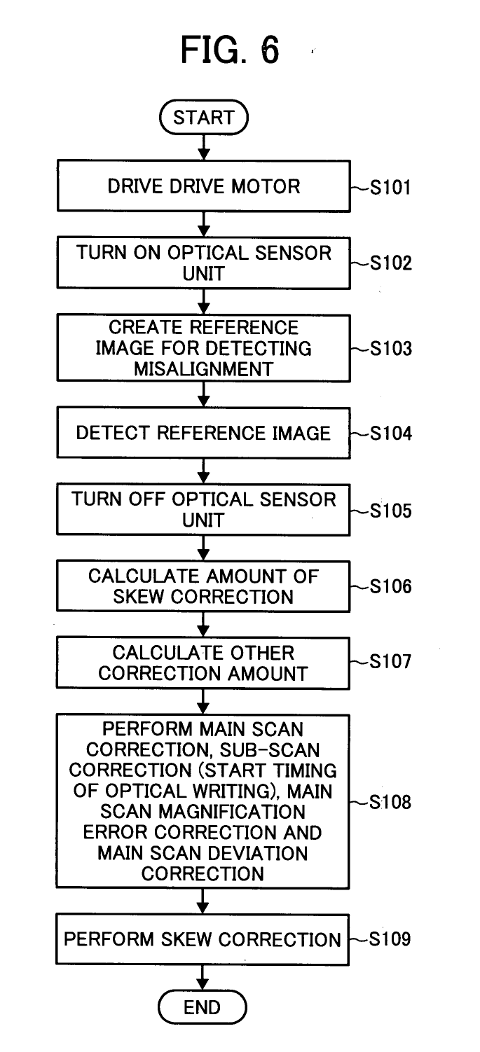

Referring now to FIG. 6, there is provided a flowchart showing an exemplary timing correction performed procedure by the controller 150 of the exemplary printer.

In the timing correction, in Step S101 the drive motor for driving the process units 6M, 6C, 6Y and 6K including the photoreceptors 1M, 1C, 1M and 1K, respectively is initiated. Subsequently, the optical sensor unit 136 is turned on in Step S102.

Next, in Step S103, the misalignment detection image for detecting misalignment is formed on the intermediate transfer belt 8. In Step S104, the misalignment detection image is detected by the optical sensor unit 136.

When the optical sensor unit 136 is turned off in Step S105, the correction amount of skew, the correction amount of the main scan position, the correction amount of the sub-scan position, the correction amount of the main scan magnification error and the main scan deviation correction amount for magenta, cyan and yellow are obtained in Steps S106 and S107.

Subsequently, based on the correction amount obtained, the main scan position correction, the sub-scan position correction or the correction of start timing of optical writing, the main scan magnification error correction, the main scan deviation correction and the skew correction are performed in Steps S108 and S109.

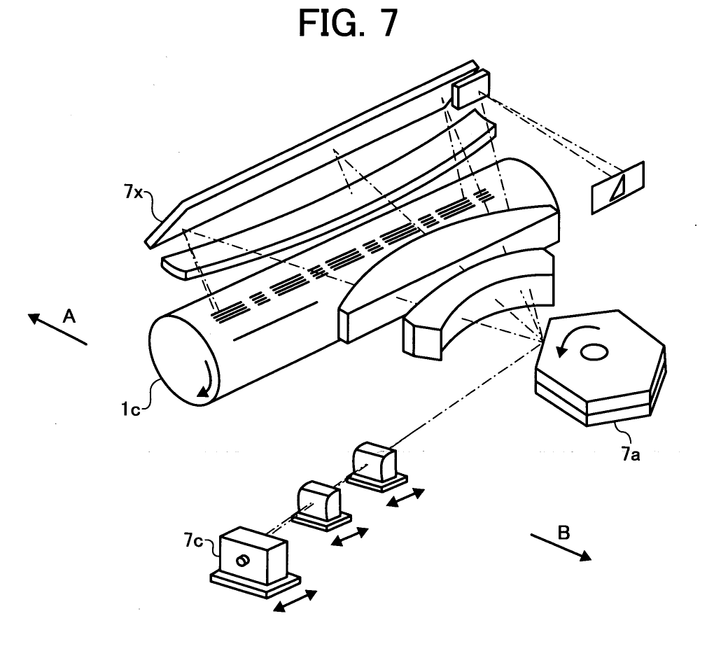

Referring now to FIG. 7, there is provided a perspective view illustrating the photoreceptor 1C and optical writing devices for cyan.

In FIG. 7, the polygon mirror 7a of an optical writing unit is structured such that two regular hexahedron mirror units are stacked one on top of another. The polygon mirror 7a is rotated in a counter-clockwise direction shown by an arrow by a polygon motor, not shown.

The photoreceptor 1C for cyan is disposed at a position shifted a predetermined distance from the polygon mirror 7a in an arrow A direction. The photoreceptor 1M for magenta is disposed at a position further shifted a predetermined distance from the photoreceptor 1C for cyan in the arrow A direction.

The photoreceptor 1Y for yellow is disposed at a position shifted a predetermined distance from the polygon mirror 7a in an arrow B direction, which is a direction opposite to the direction indicated by arrow A.

The photoreceptor 1K for black is disposed at a position further shifted by a predetermined distance from the photoreceptor 1Y for yellow in the direction indicated by arrow B, which is the opposite direction of the direction indicated by arrow A.

A laser oscillator 7c emits a writing light for cyan to the bottom mirror unit of the polygon mirror 7a. The light is reflected by one of six mirrors of the bottom mirror unit of the polygon mirror 7a after passing through a plurality of lenses.

Subsequently, the light reaches the front surface of the photoreceptor 1C via a plurality of lenses and a reflective mirror 7x.

When polygon mirror 7a rotates, a reflection angle of the writing light for cyan on the polygon mirror 7a changes to the main scan direction. Accordingly, the writing light for cyan moves from one end to the other end on the front surface of the photoreceptor 1C in a shaft line direction of the photoreceptor that is the same direction as the main scan direction. Therefore, the optical scan is performed in the main scan direction.

When the position of the writing light in the main scan direction approaches the other end of the photoreceptor 1C, the reflective surface of the polygon mirror 7a for the writing light switches to the next surface of the polygon mirror 7a.

Each time the writing light travels from one end to the other end of the photoreceptor surface, the optical scan in the main scan direction relative to the photoreceptor is performed for one line.

Scan of one line is performed approximately one dot off to the sub-scan direction, that is, the photoreceptor surface moving direction. Thus, when the start timing of optical writing is corrected per unit of time, that is, the time required for scanning one line, the writing start position in the sub-scan direction is corrected per dot.

The writing light for magenta, not shown, emitted from a laser oscillator for magenta, not shown, is reflected by the upper mirror unit of the polygon mirror 7a. After passing the photoreceptor 1C for cyan and the place above the reflective mirror 7x located above the photoreceptor 1C, the writing light for magenta reaches the photoreceptor 1M for magenta through a reflective mirror for magenta, not shown.

The writing light for yellow, not shown, emitted from a laser oscillator for yellow, not shown, is reflected by the reflective surface opposite to the reflective surface for the writing light for cyan in the bottom mirror unit of the polygon mirror 7a. Subsequently, the writing light for yellow reaches the photoreceptor 1Y for yellow through a reflective mirror for yellow, not shown.

The writing light for black, not shown, emitted from a laser oscillator for black, not shown, is reflected by the reflective surface opposite the reflective surface for the writing light for magenta in the upper mirror unit of the polygon mirror 7a. After passing the position above the reflective mirror for yellow, not shown, the writing light for black reaches the photoreceptor 1K for black through a reflective mirror for black, not shown.

Next, a description will be given of a structure of the exemplary printer.

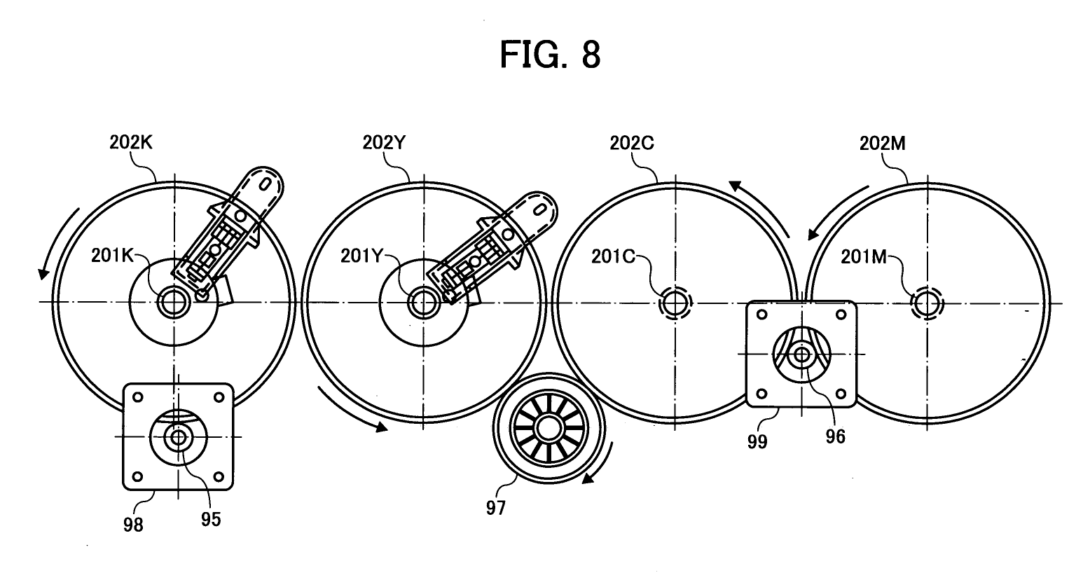

Referring to FIG. 8, there is provided an enlarged view illustrating four photoreceptor gears 202M, 202C, 202Y and 202K, and surrounding structures thereof. FIG. 8 illustrates the photoreceptor gears 202M, 202C, 202Y and 202K as viewed from a direction opposite that of the photoreceptors 1M through 1K in FIG. 1. Since the photoreceptor gears 202M, 202C, 202Y and 202K are illustrated in the reverse order of FIG. 1, the order of the colors, magenta, cyan, yellow and black are arranged in the reverse order of FIG. 1.

In FIG. 8, rotary shafts 201M, 201C, 201Y and 201K are each rotatably supported by a shaft bearing, not shown. The photoreceptor gears 202M, 202C, 202Y and 202K having a larger diameter than the diameter of the photoreceptor are fixed to the rotary shafts 201M, 201C, 201Y and 201K.

At a front side of the photoreceptor gear 202K for black in a direction perpendicular to the drawing surface is provided a first motor supporting plate 98 facing the lower portion of the photoreceptor gear 202K. The first motor supporting plate 98 supports a first drive motor 90K (shown in FIG. 3) serving as a first drive source.

At a front-side of the photoreceptor gear 202C for cyan and the photoreceptor gear 202M for magenta in a direction perpendicular to the drawing surface is provided a second motor supporting plate 99 facing a portion of the photoreceptor gears 202C and 202M.

The first drive motor 90K is fixedly mounted on the front surface of the first motor supporting plate 98. A second drive motor 90YMC (shown in FIG. 3) is fixedly mounted on the front surface of the second motor supporting plate 99.

In FIG. 8, a drive gear 95 for black is illustrated within a circular hole provided in the center of the first motor supporting plate 98 and fixed to the motor shaft of the first drive motor 90K.

The drive gear 95 is fixed to the tip of the motor shaft which penetrates the circular hole, and provided further back than the first motor supporting plate 98. The drive gear 95 meshes with the photoreceptor gear 202K as shown in FIG. 8 so that the rotary driving force of the first drive motor 90K is transmitted to the photoreceptor 1K for black through the photoreceptor gear 202K.

In FIG. 8 a color drive gear 96 is illustrated within a circular hole provided in the center of the second motor supporting plate 99 and fixed to the motor shaft of the second drive motor 90YMC.

The color drive gear 96 is fixed to the tip of the motor shaft which penetrates the circular hole, and provided further back than the second motor supporting plate 99. The color drive gear 96 meshes with both the photoreceptor gears 202C and 202M as shown in FIG. 8 so that the rotary driving force of the second drive motor 90YMC is transmitted to the photoreceptor 1C for cyan and the photoreceptor 1M for magenta through the photoreceptor gear 202C and the photoreceptor gear 202M, respectively.

A relay gear 97 is provided between the photoreceptor gear 202Y for yellow and the photoreceptor gear 202C for cyan so as to mesh with both the photoreceptor gear 202Y and the photoreceptor gear 202C. Accordingly, the rotary driving force of the second drive motor 90YMC is transmitted to the photoreceptor 1Y through the photoreceptor gear 202C, the relay gear 97 and the photoreceptor gear 202Y.

Consequently, the photoreceptor 1K serving as the first image carrier on which the toner image of a reference color, that is, black is formed is rotatively driven by the rotary driving force transmitted from the first drive motor 90K serving as the first drive source.

The three photoreceptors 1M, 1C and 1Y, and excepting the photoreceptor 1K, are rotatably driven by the rotary driving force transmitted by the second drive motor 90YMC serving as the second drive source.

According to the exemplary structure, the photoreceptors 1M, 1C and 1Y except the photoreceptor 1K serving as the first image carrier are driven by the common second drive motor 90YMC, thereby allowing a cost reduction compared with having four photoreceptors driven by four separate drive motors.

The reason for having the photoreceptor 1K for black driven by the different drive motor is that the demand for monochrome printing is greater than that for color printing. Therefore, when high-demand monochrome printing is performed, only the photoreceptor 1K for black need be driven, thereby reducing both deterioration of the other photoreceptors and/or motors as well as energy consumption.

When the monochrome printing is performed, the photoreceptor 1K is driven in the above described manner, and the transfer unit 15 of FIG. 1 causes the intermediate transfer belt 8 to be spanned in a manner such that the intermediate transfer belt 8 contacts only the photoreceptor 1K among the four photoreceptors.

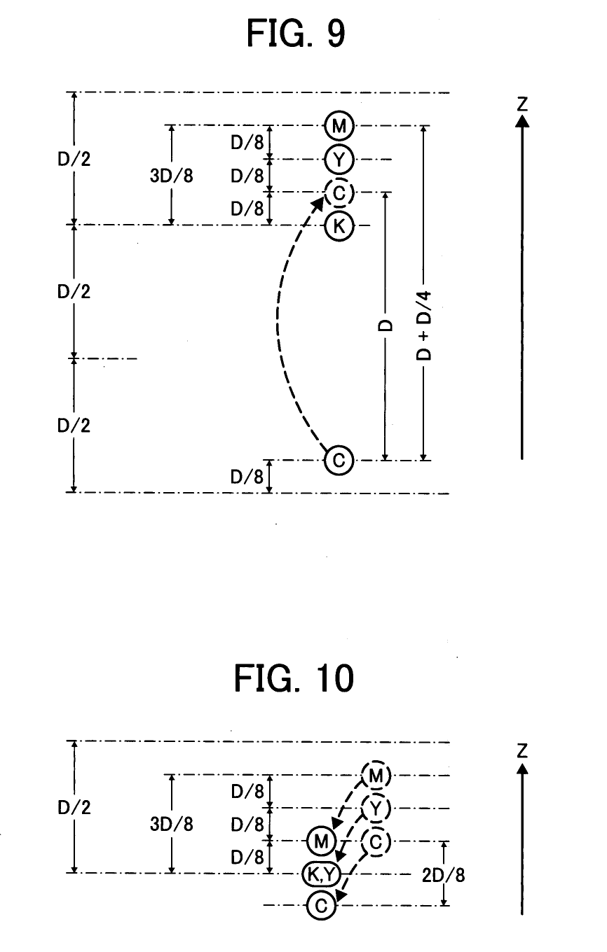

Referring now to FIG. 9, there is provided a schematic diagram for explaining a first example of misalignment of the toner images of different colors.

In FIG. 9, a letter D refers to a diameter of one dot for magenta, cyan, yellow and black. Circled letters M, C, Y and K indicate the writing start position of the electrostatic latent images of magenta, cyan, yellow and black, respectively. It should be noted that despite its circular shape, the circled letters do not indicate one dot.

A not-shown one dot for magenta, cyan, yellow and black are formed to have the same diameter as D.

With respect to cyan, there are a circled letter C and a dotted-circled letter C.

The circled letter C indicates the writing start position upon the start of optical writing before the timing correction. The dotted-circled letter C indicates the writing start position upon the start of optical writing after the timing correction.

The optical writing for magenta, cyan, yellow and black is performed on the respective photoreceptors. The relative positional drift of the dot between the photoreceptors is shown. The start position of optical writing for each color is planarly shown.

In FIG. 9, the surface moving direction of the photoreceptors is shown by an arrow Z.

In FIG. 9, the start position of the optical writing for magenta (M) and yellow (Y) is shifted downstream of the start position of the optical writing for the reference color black in the surface moving direction of the photoreceptors.

The start position of optical writing for magenta is shifted by (3D)/8 dot downstream of the start position of optical writing for black.

The start position of optical writing for yellow is shifted by (2D)/8 dot downstream of the start position of the optical writing for black.

In comparison, the start position of optical writing for cyan (C) upon the start of optical writing before the timing correction indicated by the circled C is shifted by “D+(D/4)” dot upstream of the start position of optical writing for the reference color black in the surface moving direction of the photoreceptors.

That is, the amount of misalignment is more than D/2 dot. Thus, the maximum amount of misalignment of overlapping four colors is “D+(D/4)” dot, which is the same amount of misalignment between black and cyan.

The controller of the exemplary printer corrects the start timing of the optical writing during the timing correction such that the start of optical writing is delayed for a given time for scanning one line.

Accordingly, the amount of misalignment between black and cyan is reduced to D/8 dot indicated by the dotted-circled C. The maximum amount of misalignment of all four colors is reduced to 3D/8 dot, which is the same amount of misalignment among black and magenta. The amount of misalignment can be further reduced to (7/D)/8 dot. Thus, the correction of the start timing of the optical writing can be very effective.

As shown in FIG. 9, where the start position of the optical writing for magenta, cyan and yellow upon the start of optical writing after the timing correction is shifted downstream of the start position of the optical writing for black in the photoreceptor surface moving direction, the linear velocity of the photoreceptors 1M, 1C and 1Y is configured to be slower than the linear velocity of the photoreceptor 1K.

Accordingly, it is possible to reduce the amount of misalignment of magenta, cyan, and yellow relative to black. According to the exemplary embodiment, the optical writing position of each color relative to the photoreceptors 1M, 1C, 1Y and 1K in the photoreceptor circumferential direction is configured to be the same.

Thus, when the linear velocities of the photoreceptors are similar if not identical, the time needed for the electrostatic latent images corresponding to each color to advance to the first transfer nip after passing the respective optical writing position is similar if not the same.

By contrast, when the driving speed of the second drive-motor 90YMC is configured to be slower than a reference speed so that the linear velocities of the photoreceptors 1M, 1C, and 1Y are slower than the linear velocity of the photoreceptor 1K, the time needed for the electrostatic latent images of magenta, cyan and yellow to advance to the first transfer nip after passing the respective optical writing position takes longer than the time needed for the electrostatic latent image of black.

Consequently, the toner images of magenta, cyan and yellow are each transferred to the intermediate transfer belt at a time later than a regular time. The position of the tip of the toner images is shifted further upstream in the photoreceptor surface moving direction than the original position by an amount corresponding to the linear velocity difference.

Accordingly, the amount of misalignment of the toner images of magenta, cyan and yellow relative to the toner image of black is further reduced.

After performing the timing correction, the controller 150 of the printer individually determines a driving speed of the second drive motor 90YMC from the first drive motor 90K before performing image formation for forming an image based on image information.

The linear velocity of the photoreceptor 1K driven at the reference speed, and the linear velocity of the photoreceptors 1M, 1C and 1Y, may be different as necessary.

Furthermore, when the start position of optical writing for each color after correction becomes as shown in FIG. 9, that is, when the start position of the optical writing for magenta, cyan and yellow is located downstream of the start position of the optical writing for black, the amount of misalignment between the toner image K formed on the photoreceptor 1K serving as the,firs,t image carrier upon the start of optical writing after correction and the toner images of M, C and Y formed on the photoreceptors 1M, 1C and 1Y upon the start of optical writing after correction is calculated. The amount of misalignment is the same amount of misalignment of the start position of the optical writing.

Subsequently, based on the amount of misalignment between the toner images, a middle value between the maximum value and the minimum value is calculated.

In the example shown in FIG. 9, the maximum amount of misalignment between black and magenta is 3D/8 dot. The minimum amount of misalignment between black and cyan is D/8 dot. Thus, the middle value is calculated as (1.5D/8) dot.

Next, the driving speed of the second drive motor 90YMC is set such that the linear velocity of the photoreceptors 1M, 1C and 1Y is less than the linear velocity of the photoreceptor 1K so as to accommodate the middle value.

In the subsequent image formation, the toner images of different colors are formed while the second drive motor 90YMC is driven at the driving speed thus determined, while the first drive motor 90K is driven at a standard driving speed.

Accordingly, as shown in FIG. 10, the maximum misalignment amount of (3D)/8 dot generated when there is no difference in the linear velocities between the photoreceptor 1K, and the photoreceptors 1M, 1C and 1Y can be reduced to (1.5D)/8 dot.

In other words, the maximum misalignment amount can be reduced to half the maximum misalignment amount compared with the case in which the linear velocity of the photoreceptor 1K, and the linear velocity of the photoreceptors 1M, 1C and 1Y are the same.

In FIG. 10, the dotted-circled letters M, Y and C refer to the tip position of the toner images of respective colors when the linear velocity of the photoreceptor 1K, and the photoreceptors 1M, 1C and 1Y, are different upon the start of optical writing after correction.

The circled letters M, Y and C refer to the tip position of the toner images of the respective colors when the linear velocity of the photoreceptors 1M, 1C and 1Y is different from the linear velocity of the photoreceptor 1K upon the start of optical writing after correction.

In contrast to the first example of the start position of the optical writing shown in FIG. 9, when the start position of optical writing for magenta, cyan and yellow upon the start of optical writing after correction is located downstream of the start position of the optical writing for black in the photoreceptor surface moving direction, the controller individually determines the driving speed of the second drive motor 90YMC which allows the linear velocity of the photoreceptors 1M, 1C and 1Y to be greater than the linear velocity of the photoreceptor 1K so as to accommodate the middle value described above.

In other words, when the tip position of each of the toner images of magenta, cyan and yellow is shifted downstream of the original position in the photoreceptor surface moving direction, the maximum misalignment amount can be reduced to half the amount compared with the case in which there is no difference between the linear velocities of the photoreceptors.

The controller 150 of the exemplary printer performs a combination of the timing correction and separate determination of the driving speeds after a predetermined time elapses in a state in which the power is ON.

During a continuous printing operation, after the predetermined time elapses, the continuous printing operation is temporarily stopped, and the controller 150 performs the timing correction and separate determination of the driving speeds.

According to the exemplary embodiment, even if a long period of time elapses after the previous timing correction was performed and thus causing the start timing of the optical writing for each color to shift from an appropriate timing, the start timing of the optical writing is corrected to the appropriate timing, after which the image forming processing is performed.

Accordingly, even if the timing correction is not performed for a long period of time in a state in which the power is ON, deterioration in the alignment of the toner images of different colors in the sub-scan direction can be reduced, if not prevented entirely.

The controller 150 of the printer according to the exemplary embodiment performs the timing correction and individually determines the driving speeds when a predetermined number of sheets is printed out.

When the predetermined number of sheets is printed out during a continuous printing operation, the continuous printing operation is temporarily stopped. The controller performs the timing correction and individually determines the driving speeds.

According to the exemplary embodiment, even if a long period of time elapses after the previous timing correction was performed causing the start timing of the optical writing for each color to shift from an appropriate timing, the start time of the optical writing is corrected to the appropriate time, and then the image forming processing is performed.

Accordingly, even if the timing correction is not performed for a long period of time in a state in which the power is ON, deterioration in the alignment of the overlapped toner images of different colors in the sub-scan direction can be reduced, if not prevented entirely.

It should be noted that printing a predetermined number of sheets refers to a similar if not the same operation as performing a predetermined number of image forming operations.

Next, a description will be given of a printer according to other exemplary embodiments. Unless otherwise specified, the structure of the printer according to these other exemplary embodiments is similar to, if not the same as, the structure as the printer according to the exemplary embodiment described above.

### Second Exemplary Embodiment

The printer according to a second exemplary embodiment includes at least three photoreceptors 1M, 1C and 1Y for magenta, cyan and yellow, respectively, driven by the second drive motor 90YMC serving as the second drive source. For present purposes, the photoreceptors 1M and 1C are, of course, the non-yellow photoreceptors.

The color yellow is difficult for the human eye to discern. Thus, misalignment of the toner image of yellow (Y) relative to toner images of magenta (M), cyan (C) and black (K) may be difficult to recognize compared with misalignment of other toner images.

Consequently, even if the misalignment of the toner image Y is significant relative to the toner images of other colors, the misalignment of the toner image Y may be difficult to recognize.

Accordingly, the controller 150 individually determines the driving speed of the second drive motor 90YMC without taking into account the amount of misalignment of the toner image Y relative to the toner image K that is the reference color.

In particular, the amount of misalignment between the toner image K formed on the photoreceptor 1K serving as the first photoreceptor upon the start of optical writing after correction, and the toner images M and C formed on the photoreceptors 1M and 1C, respectively, upon the start of the respective optical writing after correction is calculated.

Subsequently, the middle value between the maximum value and the minimum value is calculated. The maximum value may be taken from either the amount of misalignment between toner images K and M, or the amount of misalignment between tone images of K and C. The minimum value may be taken from the other misalignment amount not used for the maximum value.

The driving speed of the second drive motor 90YMC is determined such that the linear velocity difference corresponding to the middle value falls between the linear velocity of the photoreceptor 1K, and the linear velocity of the photoreceptors 1M, 1C and 1Y.

According to the second exemplary embodiment, compared with a case in which the driving speed of the second drive motor 90YMC is set taking into consideration of the amount of the misalignment of toner image Y relative to the toner image K, the amount of the misalignment of the toner images M and C relative to the toner image K can be reduced.

Accordingly, even if the amount of misalignment of the toner image Y relative to the toner image K is significant, such misalignment of the toner images may be difficult to see and hence is not a problem.

### Third Exemplary Embodiment

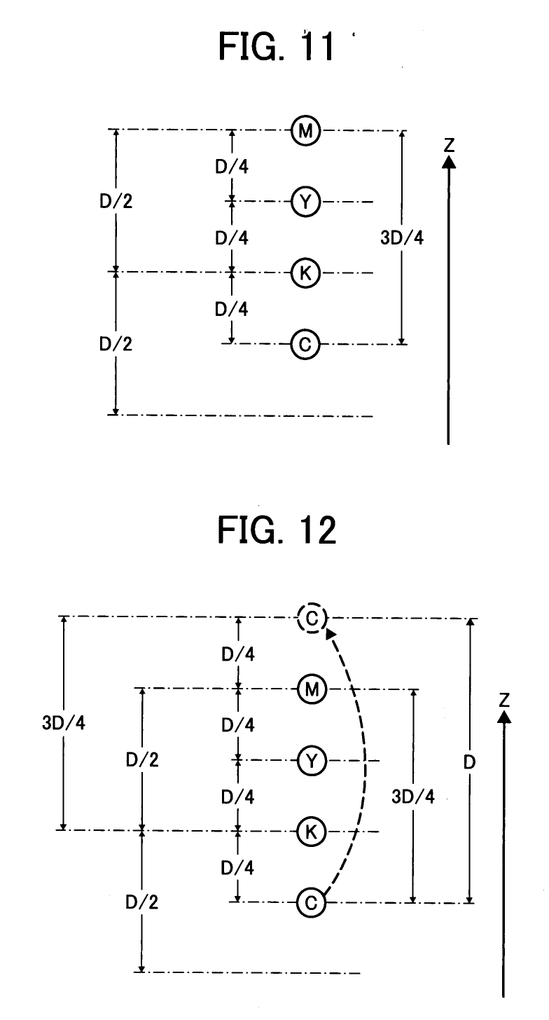

Referring now to FIG. 11, there is provided a schematic diagram illustrating the misalignment of the toner images according to a third exemplary embodiment.

The start position of optical writing for each color upon optical writing after correction is shifted in a manner as shown in FIG. 11. In other words, after the optical writing timing for each color is corrected, the start position of the optical writing for magenta and yellow is shifted downstream of the start position of the optical writing for black in the photoreceptor surface moving direction.

By contrast, the start position of the optical writing for cyan is shifted upstream of the start position of the optical writing for black in the photoreceptor surface moving direction.

According to the third exemplary embodiment, at least one of the start positions of the optical writing for magenta, cyan and yellow upon the start of optical writing after correction is shifted upward, that is, not all of the start positions of the optical writing for magenta, cyan and yellow are shifted either upward or downward. The rest of the start positions of the optical writing other than the start position of the optical writing that is shifted upward are shifted downward.

In such a case, the maximum misalignment does not occur between the reference color black and the other colors. Instead, the maximum misalignment occurs between two colors other than black.

As shown in FIG. 11, the maximum misalignment of 3D/4 dot occurs between magenta and cyan, for example.

In such a case, even if the linear velocity of the photoreceptor 1K and the linear velocities of the photoreceptor 1M, 1C and 1Y are different, the maximum misalignment amount remains the same as the maximum misalignment amount of 3D/4 dot between magenta and cyan when there is no difference in the linear velocities. Thus, the misalignment may not be reduced by the linear velocity difference.

However, when the correction of the start timing of the optical writing at the timing correction is devised, the misalignment amount can be reduced by the linear velocity difference.

Specifically, when the start position of the optical writing for any of magenta, cyan and yellow is shifted by ½ dot or more relative to the reference color black, similar to the related art image forming apparatus, the exemplary printer corrects the start timing of the optical writing for the misaligned color regardless of any conditions.

When corrected in such a manner, the misalignment amount of the start timing of the optical writing for magenta, cyan and yellow relative to black is ½ or less as shown in FIG. 11.

However, it may not be possible to further reduce the amount of the misalignment by the linear velocity difference. Thus, instead of focusing on the misalignment of magenta, cyan and yellow relative to black at the timing correction, the misalignment between any of the two colors (any two photoreceptors except the photoreceptor 1K) among magenta, cyan and yellow except black can be considered.

Referring now to FIG. 12 there is provided a schematic diagram illustrating the start position of the optical writing for each color.

In FIG. 12, two start positions of optical writing for cyan are illustrated. The circled C refers to the position upon the start of optical writing before correction. The dotted-circled C refers to the position upon the start of optical writing after correction.

Upon the start of optical writing before correction, the amount of the misalignment of the start position of the optical writing for magenta, cyan and yellow relative to black is ½ dot or less. In such a case, conventionally, no correction was performed on the start timing of the optical writing.

When looking at the amount of the misalignment of the start position of optical writing between magenta, cyan and yellow, instead of looking at the amount of the misalignment between black, and magenta, cyan and yellow, the amount of the misalignment is D/4 dot, (3D)/4 dot and (2D)/4 dot between magenta and yellow, between magenta and cyan, and between yellow and cyan, respectively.

The amount of misalignment between magenta and cyan is the greatest. The misalignment amount of (3D)/4 dot between magenta and cyan is greater than ½ dot. Therefore, the amount of the misalignment can be reduced by focusing on three of the four colors, namely magenta, cyan and yellow.

When the start timing of the optical writing for cyan is delayed for a given time for scanning one line, the amount of the misalignment between magenta and cyan is reduced to D/4 dot as shown by the dotted-circled C.

The maximum amount of misalignment among three colors is reduced from (3D)/4 dot to (2D)/4 dot. The maximum amount of misalignment including black is (3D)/4 dot between cyan and black, which is the same amount as the amount before correction.

However, what is different after correction is that the start position of the optical writing for three colors other than black is located downstream of black in the photoreceptor surface moving direction.

The start position of the,optical writing for three colors can be located upstream of black through correction in the photoreceptor surface moving direction.

When focusing on the three colors other than black, the maximum amount of misalignment is reduced as shown in FIG. 12. The tips of the toner images of the three colors are relatively adjusted against the toner image K for black by using the linear velocity difference described above. Accordingly, the maximum amount of the misalignment of all four colors can be maintained at the same amount as that of three colors magenta, cyan and yellow.

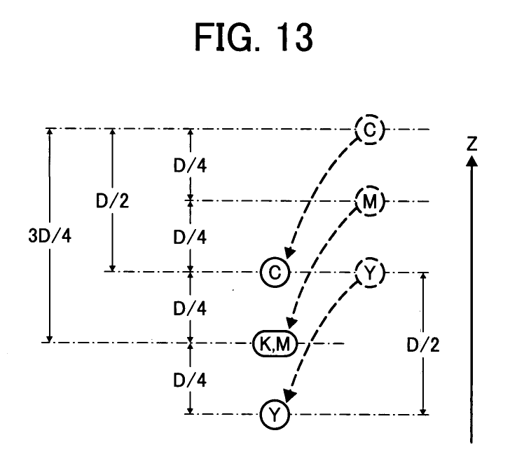

For example, as shown in FIG. 12, the maximum amount of misalignment among all four colors is (3D)/4 dot. When the linear velocity is different, the maximum amount of misalignment among all four colors can be reduced to (2D)/4 dot as shown in FIG. 13.

In the controller of the printer, the amount of misalignment between the toner images on all possible pairs of the photoreceptors 1M, 1C and 1Y, for example, 1M and 1C, 1M and 1Y, and 1C and 1Y, driven by the second drive motor 90YMC is calculated. Based on that calculation, the start time of the optical writing relative to each of the photoreceptors 1M, 1C and 1Y is then individually corrected.

According to the present exemplary embodiment, the amount of misalignment in the image forming processing can be reduced compared with a case in which the start timing of the optical writing for magenta, cyan and yellow is determined at the timing correction processing so as to suppress the amount of misalignment less than or equal to ½ relative to black.

It should be noted that, similar to the second exemplary embodiment, the controller 150 of the present exemplary embodiment individually determines the driving speed of the second drive motor 90YMC without taking the amount of misalignment of yellow relative to the reference color black into consideration.

### Fourth Exemplary Embodiment

A description will now be provided of a fourth exemplary embodiment.

Even after the timing correction, some misalignment remains upon the start of optical writing. According to the fourth exemplary embodiment, the amount of misalignment remaining at the start of optical writing after timing correction is calculated by adding a predetermined value to a theoretical amount of misalignment.

Specifically, similar to the exemplary embodiments described above, the theoretical amount of misalignment is calculated first. Subsequently, the predetermined amount is added to the theoretical amount of misalignment, and the result used as the amount of misalignment.

In the actual printer, optical sensor unit detection time error and/or some other printer-specific factors may cause the actual amount of misalignment to shift by a predetermined amount from the theoretical amount of misalignment.

For example, the actual amount of misalignment may substantially be expressed as G+H regardless of a variable G, where the variable G is the theoretical amount of misalignment and a variable H is the predetermined amount. Therefore, the predetermined amount is added to the theoretical amount of misalignment.

The predetermined amount, or the variable H, of each product may be measured during a test run before shipment, and is in any case established by experiment.

### Fifth Exemplary Embodiment

A description will now be given of a fifth exemplary embodiment.

According to the fifth exemplary embodiment, the controller 150 of the printer switches the image forming speed between a first printing speed and a second printing speed based on a predetermined instruction, for example, an input operation by a user relative to the control display unit, printer setting information transmitted from a PC, or the like.

The first printing speed is designed for a low-speed printing mode. The second printing speed is designed for a fast-speed printing mode.

Accordingly, when the image forming speed is different, the linear velocities of the photoreceptor, the intermediate transfer belt, and the like differ.

Therefore, at timing correction, the start timing of the optical writing for the first printing speed and the start timing of the optical writing for the second printing speed of all the photoreceptors are individually corrected for all the photoreceptors 1M, 1C, 1Y and 1K.

Specifically, the controller 150 individually determines the driving speeds of the first drive motor 90K and the second drive motor 90YMC for the first printing speed and the second printing speed.

### Sixth Exemplary Embodiment

A description will now be given of a sixth exemplary embodiment.

According to the sixth exemplary embodiment, the driving speed of the first drive motor 90K is not fixed but variable, whereas the driving speed of the second drive motor 90YMC is configured to be an invariable fixed value.

Specifically, the driving speed of the first drive motor 90K is individually determined based on the amount of misalignment of the toner image remaining upon the start of optical writing after timing correction, and the fixed value of the driving speed of the second drive motor 90YMC.

As shown in FIG. 8, the photoreceptor 1Y receives the driving force from the second drive motor 90YMC through the photoreceptor gear 202C and the relay gear 97. The photoreceptor gear 202Y does not directly receive the driving force of the color drive gear 96.

Therefore, compared to directly receiving the driving force of the color drive gear 96, the rotary speed of the photoreceptor 1Y tends to be unstable. In such a case, when the driving speed of the second drive motor 90YMC is changed, there is a possibility that the photoreceptor 1Y may be driven at a linear velocity which is not the theoretical linear velocity, and consequently, the accuracy of reduction of misalignment may be degraded. Thus, the driving speed of the second drive motor 90YMC is configured to be a fixed value, and the driving speed of the first drive motor 90K without the relay gear is configured to be variable.

According to the printer of the present exemplary embodiment, when the driving speed of the first drive motor 90K is a fixed value, the following effect is attained. That is, in general, in the image forming apparatus, the reference color is, for example, black. Based on the reference color black, control parameters for non-reference colors other than black are changed as necessary to create a control program.

However, when the driving speed of the first drive motor 90K corresponding to the reference color black is variable, the conventional control program needs to be significantly modified.

On the other hand, when the driving speed of the first drive motor 90K corresponding to the reference color black is a fixed value, the conventional control program may be used in the exemplary printer without significantly changing the conventional control program, thus providing valuable compatibility.

The foregoing description is of the exemplary printer in which the toner images carried on each of the photoreceptors are overlappingly transferred onto the intermediate transfer belt. Subsequently, the toner images are secondarily transferred to the recording medium at once.

It should be noted, however, that the present invention is not limited to these embodiments, and various variations and modifications may be made without departing from the scope of the present invention.

Thus, the present invention may be applied to an image forming apparatus in which the toner images carried on the photoreceptors are overlappingly transferred onto the recording medium held on the surface of a medium moving in an endless loop such as a sheet conveyance belt.

Further, elements and/or features of different exemplary embodiments may be combined with each other and/or substituted for each other within the scope of this disclosure and appended claims.

Still further, any one of the above-described and other exemplary features of the present invention may be embodied in the form of an apparatus, method, system, computer program and computer program product. For example, any of the aforementioned methods may be embodied in the form of a system or device, including, but not limited to, any of the structure for performing the methodology illustrated in the drawings.

One or more embodiments of the present invention may be conveniently implemented using a conventional general purpose digital computer programmed according to the teachings of the present specification, as will be apparent to those skilled in the computer art.

Appropriate software coding can readily be prepared by skilled programmers based on the teachings of the present disclosure, as will be apparent to those skilled in the software art.

One or more embodiments of the present invention may also be implemented by the preparation of application specific integrated circuits or by interconnecting an appropriate network of conventional component circuits, as will be readily apparent to those skilled in the art.

Any of the aforementioned methods may be embodied in the form of a system or device, including, but not limited to, any of the structure for performing the methodology illustrated in the drawings.

Furthermore, any of the aforementioned methods may be embodied in the form of a program. The program may be stored on a computer readable media and is adapted to perform any one of the aforementioned methods, when run on a computer device (a device including a processor).

Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of a built-in medium include, but are not limited to, rewriteable non-volatile memories, such as ROMs and flash memories, and hard disks.

Examples of a removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such exemplary variations are not to be regarded as a departure from the spirit and scope of the present invention, and all such modifications as would be obvious to one skilled in the art are intended to be included within the scope of the following claims.

The number of constituent elements, locations, shapes and so forth of the constituent elements are not limited to any of the structure for performing the methodology illustrated in the drawings.

What is claimed is:

1. An image forming apparatus, comprising:
at least three image carriers including first, second and third image carriers each having a movable surface, configured to bear a visible image thereon;
a first drive source configured to transmit a driving force to at least the first image carrier;
a second drive source configured to transmit a driving force to at least two image carriers other than the first image carrier;
at least one visible image forming mechanism configured to form a visible image on the image carriers based on image information;
a transfer unit configured to overlappingly transfer the visible images borne on the image carriers to a surface of a transfer member;
an image detector configured to detect the visible images on the transfer member and detect a misalignment detection image formed of a predetermined visible image for detecting misalignment of the visible images when overlapped;
a controller configured to form the misalignment detection image on the image carriers, transfer the misalignment detection image onto the surface of the transfer member, and perform a timing correction to correct a start timing of image formation on the image carriers based on a detection timing of the image detector that detects the visible images in the misalignment detection image so as to reduce misalignment of the overlapped visible images,
wherein the controller calculates an amount of misalignment of the overlapped visible images that remain at the start timing of image formation based on the start timing of image formation after the timing correction, and individually determines driving speeds of the first drive source and the second drive source based on the amount of misalignment of the overlapped visible images, and
wherein the controller further performs image forming processing to form an image based on the image information while separately driving the first drive source and the second drive source driven at the respective driving speeds separately determined.

2. The image forming apparatus according to claim 1, wherein the controller calculates the amount of misalignment of the overlapped visible images among the visible image formed on the first image carrier at the start timing of image formation after the timing correction and the visible images formed on at least two other image carriers at the separate start timing of image formation after the timing correction, and individually determines the driving speeds of the first and the second drive sources based on a middle value between a maximum value and a minimum value of the calculation result.

3. The image forming apparatus according to claim 1, wherein the second drive source drives at least three image carriers including a second image carrier on which a visible image of yellow is formed, and third and fourth image carriers on which visible images of different colors other than yellow are each formed, and
wherein the controller calculates the amount of misalignment of the overlapped visible images among the visible image formed on the first image carrier at the start timing of image formation after the timing correction and the visible images of non-yellow formed on the third image carrier or the fourth image carrier at the separate start timing of image formation after the timing correction, and individually determines the driving speeds of the first drive source and the second drive source based on a middle value between a maximum value and a minimum value of the calculation result.

4. The image forming apparatus according to claim 1, wherein the controller calculates the amount of misalignment of the overlapped visible images among the visible image formed on the first image carrier and the visible images formed on two or more other image carriers driven by the second drive source, and separately corrects the start timing of image formation relative to each image carrier based on a calculation result.

5. The image forming apparatus according to claim 1, wherein the controller calculates the amount of misalignment of the overlapping toner images among the visible images formed on two image carriers driven by the second drive source, and separately corrects the start timing of image formation relative to each image carrier based on a calculation result.

6. The image forming apparatus according to claim 1, the controller calculates the amount of misalignment of the overlapped visible images remaining at the start timing of image formation after the timing correction by adding a predetermined value to the amount of misalignment based on the detection timing of the visible images in the misalignment detection image.

7. The image forming apparatus according to claim 1, wherein the controller switches image forming speeds between a first printing speed and a second printing speed different from the first printing speed in accordance with a predetermined instruction when image forming processing is performed,
wherein the controller separately corrects the start timing of image formation at the first printing speed and the start timing of image formation at the second printing speed for all the image carriers, and
wherein the controller determines the driving speeds of the first drive source and the second drive source for the first printing speed and the second printing speed.

8. The image forming apparatus according to claim 1, wherein the driving speed of the first drive source is a fixed value, and
wherein the controller determines the driving speed of the second drive source based on the fixed value and the amount of misalignment of the overlapped visible images remaining at the start timing of image formation after the timing correction.

9. The image forming apparatus according to claim 1, wherein the driving speed of the second drive source is a fixed value, and
wherein the controller determines the driving speed of the first drive source based on the fixed value and the amount of misalignment of the overlapped visible images remaining at the start timing of image formation after the timing correction.

10. The image forming apparatus according to claim 1, further comprising:
an opening from which a plurality of image carriers is individually detached from the image forming apparatus.

11. The image forming apparatus according to claim 10, further comprising:
a plurality of chargers configured to individually charge the plurality of the image carriers; and
a plurality of holders each configured to hold each one of the plurality of chargers and each one of the plurality of image carriers as a process unit integrally detachable from the image forming apparatus.

12. The image forming apparatus according to claim 1, wherein the controller controls the timing correction and calculates an amount of misalignment of the overlapped visible images that remain at the start timing of image formation based on the start timing of image formation after the timing correction, and individually determines driving speeds of the first drive source and the second drive source based on the amount of misalignment of the overlapped visible images when power is supplied to the image forming apparatus.

13. The image forming apparatus according to claim 1, wherein the controller controls the timing correction and calculates an amount of misalignment of the overlapped visible images that remain at the start timing of image formation based on the start timing of image formation after the timing correction, and individually determines driving speeds of the first drive source and the second drive source based on the amount of misalignment of the overlapped visible images after each predetermined time.

14. The image forming apparatus according to claim 1, wherein the controller controls the timing correction and calculates an amount of misalignment of the overlapped visible images that remain at the start timing of image formation based on the start timing of image formation after the timing correction, and individually determines driving speeds of the first drive source and the second drive source based on the amount of misalignment of the overlapped visible images after a predetermined number of image forming operations takes place.
